(19) United States
(12) Patent Application Publication
(10) Pub. No.: US 2001/0027892 A1
(43) Pub. Date: Oct. 11, 2001

(54) Traction kinking system for applying power to a trailing section of an articulated vehicle

(76) Inventors: Nathan Masters, Raceland, LA (US); Connie Masters, Raceland, LA (US); Andrew Masters, Raceland, LA (US)

Correspondence Address: Nathan Masters, 3168 Hwy 308, Raceland, LA, 70394, US

(21) Appl. No.: 09/776,211

(22) Filed: Feb. 2, 2001

Related U.S. Application Data
(60) Provisional application No. 60/179,745, filed on Feb. 2, 2000.

(51) Int. Cl. B62D 5/00

(52) U.S. Cl. 180/403; 180/400

(57) ABSTRACT

This invention relates to an articulated machine having at least two sections with pivot points between each section, at least two sections of which are steerable. The front section is steered by a human or by a master-control system The trailing steerable section is steered by a slave controller utilizing inputs from sensors. The traction kinking system applies power to the wheels of the trailing machine section to increase or decrease the speed of the trailing section as necessary to decrease the lateral forces on the section, thereby using the traction of the wheels on the pavement to help “kink” the section behind the powered wheels with respect to the section in front of the powered wheels. By reducing these forces, the chance that the wheels will slip to the side is reduced. The system is shown as applied to a dolly and trailer pulled behind a tractor-trailer rig.

### DESCRIPTION

This patent is associated with provisional patent 60/179,745.

### TECHNICAL FIELD

This invention relates to a steering system for a series of mobile, articulated, pivotally-connected machine sections, and more particularly to a steering system that automatically controls steerable wheels to provide automatic steering of some machine sections. The preferred embodiment of the invention demonstrates a way of applying the principles of the invention to over-the-road tractor-trailer combinations.

### BACKGROUND OF THE INVENTION

Longer combination vehicles, tractor-trailer rigs with at least two trailers, have always been plagued by the two problems of instability and lack of maneuverability. The standard Type A dolly has achieved some degree of success over the years by striking a mid-point between the two problems. It is not excessively unstable and does have a limited degree of maneuverability. However, it is not as maneuverable as desired, and it continues to behave in an unstable manner in side winds or for sudden changes in direction.

The Type B dollies have been somewhat effective against the maneuverability problems and the instability. However, they cause other problems such as stresses on the rear of the forward trailer and unloading delays due to difficulty in accessing the back of the forward trailer.

Steerable Type A dollies address the stability problems, but are even less maneuverable than Standard Type A dollies.

Over-the-road transport companies are finding it difficult to compete with other freight haulers because of weight limits on the roads and bridges. Multi-trailer arrangements are a possible solution to some of these problems because they spread the load over a longer stretch of pavement and reduce the columnar loading on bridges. The transportation industry is experimenting with more sophisticated types of dollies in an effort to overcome the instabilities and the lack of maneuverability that plague these multi-trailer arrangements. As the steering of the trailing sections becomes more complex, it is often the case that the pull of the previous section is not in the direction that the wheels are intended to travel. When this is the case, it is necessary to have an alternate method of applying power to the trailing section.

### SUMMARY OF THE INVENTION

This invention relates to the application of power to the wheels of the controller-steered section in such a manner as to reduce the lateral forces on the wheels, thereby reducing the amount of wheel slippage. The controller calculates the amount of acceleration or braking to apply to the wheels by detecting the amount of sideways force on the wheels of the controller-steered machine section. This reduction in wheel slippage aids in the creation of a reliable system for steering several trailers in tandem

### BRIEF DESCRIPTION OF THE DRAWINGS

FIG. 1 is a diagrammatic view of an embodiment of a geared cornering mode dolly with traction kinking, towed behind a tractor-trailer combination rig

FIG. 2 is a diagrammatic perspective plan view of geared cornering mode dolly with traction kinking

FIG. 3 is a diagrammatic view of a geared cornering mode dolly with traction kinking from top looking down

FIG. 4 is a diagrammatic back plan view of a geared cornering mode dolly with traction kinking

FIG. 5 is a diagrammatic end view detail of transverse axle and axle hanger assembly

FIG. 6 is a diagrammatic detail of location of regulator switches on axle hanger assembly

FIG. 7 is a diagrammatic view of the kinking logic system

FIG. 8 is a diagrammatic view of air pressure converter detail

FIG. 9 is a diagrammatic view of the details of the air motor assembly

FIG. 10 is a diagrammatic view of the preferred embodiment of invention using a switchable geared dolly with traction kinking

FIG. 11 is a diagrammatic view of the alternative embodiment of the invention using hydraulic cylinders to steer dolly

FIG. 12 is a diagrammatic view of the valve box diagram of valves used for switching between stability and cornering modes of switchable hydraulic dolly

FIG. 13 is a diagrammatic view of the valves used for switching between maximum and moderate modes of switchable hydraulic dolly

FIG. 14 is a diagrammatic view of the a double-axle wagon utilizing the switchable geared type of steering and traction kinking to control towing characteristics of the trailer

FIG. 15 is a diagrammatic view of the switchable “digital dolly” with traction kinking utilizing a microprocessor for steering the dolly

### DETAILED DESCRIPTION

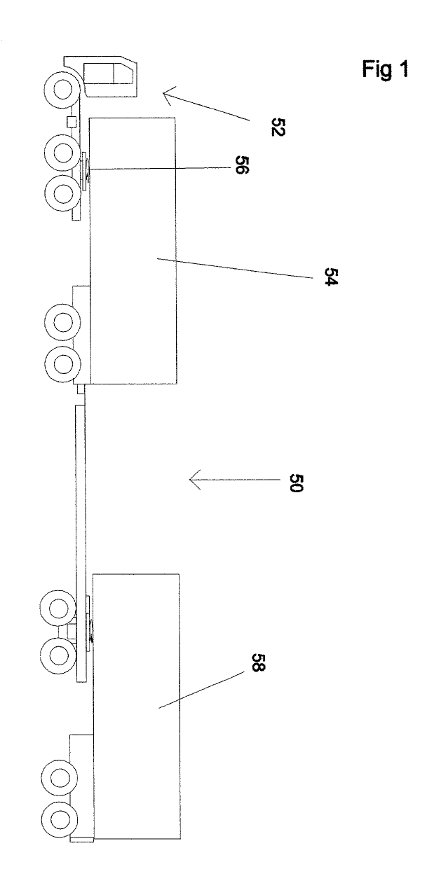

FIG. 1—Geared Cornering Mode Dolly with Traction Kinking Towed Behind a Tractor-Trailer Combination Rig

FIG. 1 illustrates a typical application of a geared cornering mode dolly 50 with traction kinking which is an alternate embodiment of the invention. A tractor 52 of a tractor-trailer combination has a forward trailer 54 coupled thereto via a fifth wheel 56, while a second rear trailer 58 is coupled to the forward trailer 54 via the dolly 50 we will be describing.

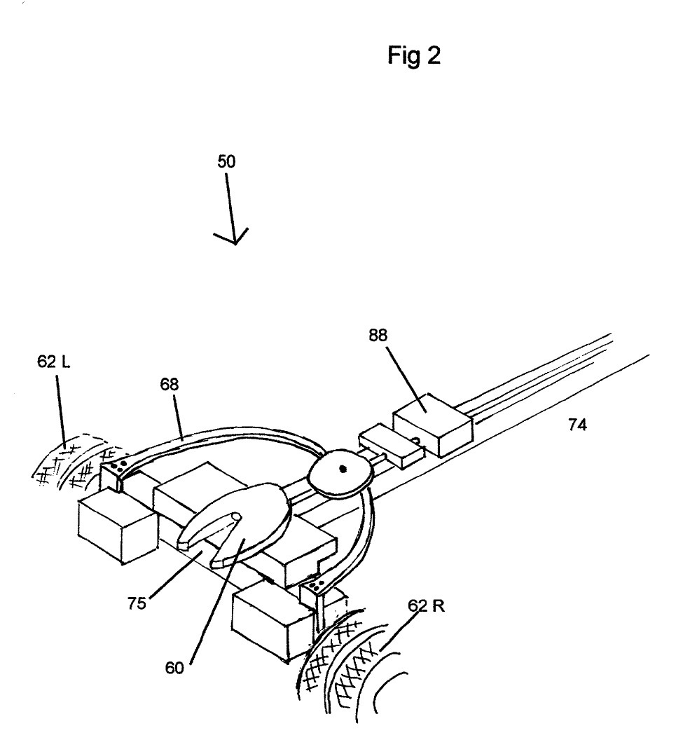

FIG. 2—Geared Cornering Mode Dolly with Traction Kinking in Perspective

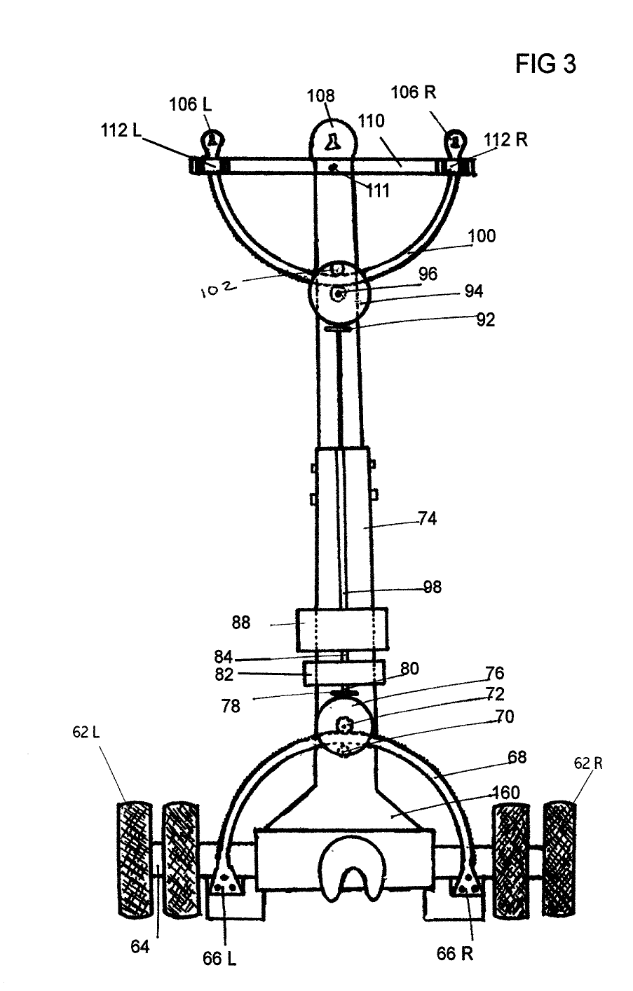

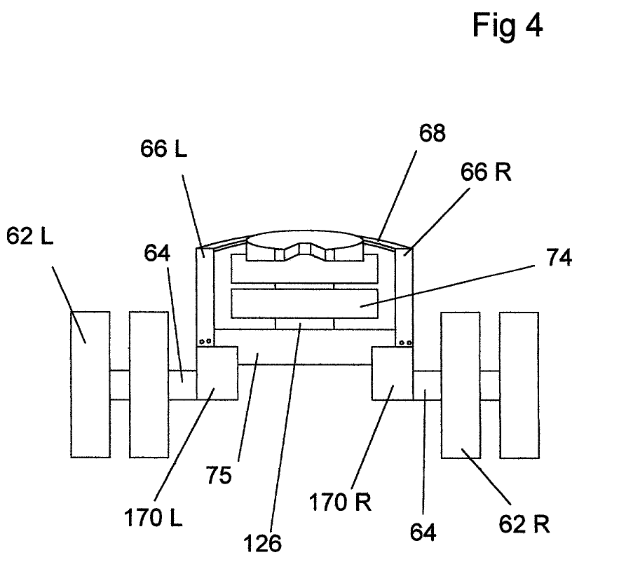

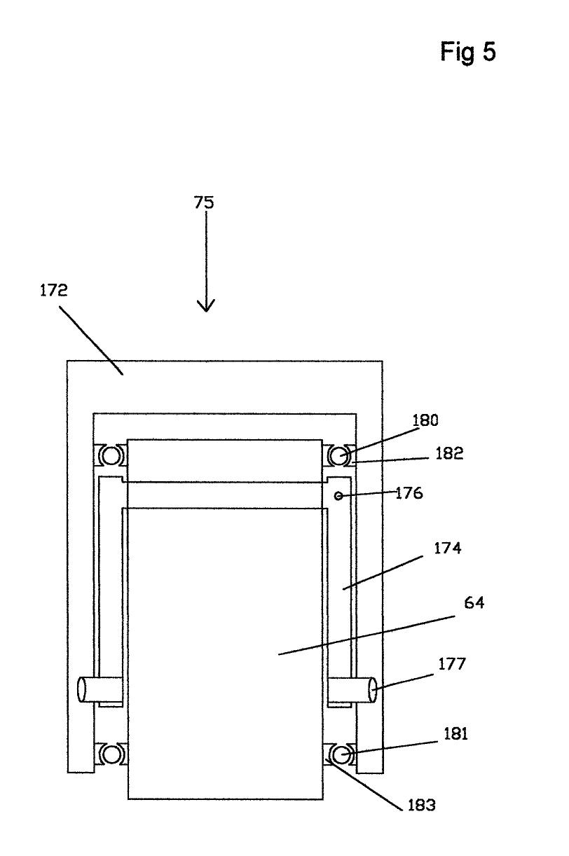

FIG. 2 shows the back section of the geared cornering mode dolly with traction kinking 50 in a perspective view. Referring to this figure, the dolly 50 has a rigid main dolly frame 74, which in this embodiment will be coupled to the front end of the rear trailer 58 (FIG. 1) via a fifth wheel 60. The fifth wheel is mounted on an elevated section of a main dolly frame 74. The back part of the dolly 50 has two main sections. The main dolly frame 74 comprises the central rigid structural member. A transverse axle hanger assembly 75 is mounted on a vertical axle hanger central pivot 126 (FIG. 4) which extends below the main dolly frame 74 and is able to swivel around on this axle hanger central pivot 126 (FIG. 4). The details of the axle hanger assembly 75 and the method of connection with a transverse axle 64 (FIG. 5) are shown in FIG. 5. The transverse axle 64 (FIG. 3) and two spaced pairs of running wheels 62R and 62L, which it carries, are mounted beneath the middle of the axle hanger assembly 75 by any conventional suspension system, In this embodiment the suspension system is omitted for clarity of illustration since it is a standard assembly. The gear train, which controls the steering of the transverse axle 64 (FIG. 3), is mounted above the main dolly frame 74 and generally in front of the axle 64 (FIG. 3). This gear train includes a rear partial-circular track 68, which attaches rigidly to the axle 64 (FIG. 3), a main gearbox 88, and the several components in between. More details of the back section of the dolly 50 will be discussed when we examine FIG. 3 and FIG. 4.

The front of the main dolly frame 74 with the hitch latches is not shown in this view and will be discussed later. Most of the smaller working parts of the dolly steering system are mounted along the top of the main dolly frame. These will be discussed when we examine FIG. 3.

FIG. 3—View of Geared Cornering Mode Dolly with Traction Kinking from Top Looking Down

FIG. 3 shows a view of the primary sections of the dolly 50 from above. The transverse axle 64, which was discussed above, has an attachment at the top via a track attachment assembly 66L and 66R to the extremities of a large rear partial-circular track 68. This partial-circular track must be somewhat longer than a semicircle to allow for rotations of more than 90 degrees. The attachment assemblies 66L and 66R are designed solidly, but they attach to the back of the transverse axle 64 so that the space directly above the axle 64 and forward and slightly backward is empty. This allows more than a full 180 degrees of rotation of the axle hanger assembly 75 (FIG. 2) about a vertical axle hanger central pivot 126 (FIG. 4).

The bottom of the rear partial-circular track 68 is in the same plane with the top of the main dolly frame 74. The gear teeth on the front of the rear partial-circular track 68 are sized to mesh with the teeth of a small gear 72 mounted on the main dolly frame 74. This rear partial-circular track 68 passes between a roller 70 and the small gear 72 on the top of the main axial member of the main dolly frame 74. The roller 70 and the gear 72 are positioned to press tightly against the sides of the rear partial-circular track 68 so that as he gear 72 rotates, it causes the rear partial-circular track 68 to move between the gear 72 and the roller 70. This in turn will cause the axle 64 to rotate about a vertical axis, changing the orientation of the dolly running wheels 62L and 62R.

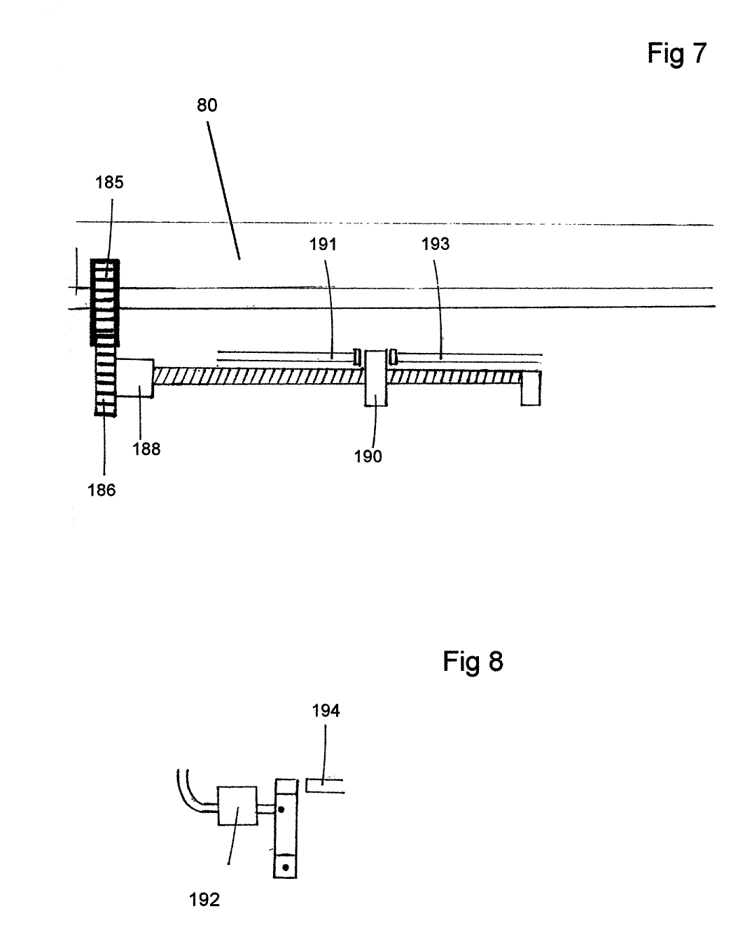

The small gear 72 is rigidly attached to a large 90-degree gear 76 above it, both of which rotate about the same axis. The large 90-degree gear 76 is mounted high enough to easily stay clear of the rear partial-circular track 68 as it moves. The large 90-degree gear 76 has 45-degree teeth along its outer lower edge designed to mesh with a smaller 90-degree gear 78 rotating at a 90-degree angle to it and located directly below its front edge. This smaller gear 78 which is rotating around an axis parallel to the main axial member of the main dolly frame 74 is mounted on a shaft 80 which passes into a kinking logic system gearbox 82 through the back wall of the kinking logic system gearbox 82. This kinking logic system gearbox 82 keeps up with the orientation of the rear partial-circular track 68 and of the transverse axle 64 in order to determine when air pressure for the kinking drive system should be disabled and/or switched to braking air pressure. More details of the operation of the kinking logic system will be discussed in FIG. 7.

A shaft 84 coming out through the front wall of the kinking logic system gearbox 82 goes through another wall and into the main gearbox 88. The purpose of this main gearbox 88 is to change the ratio and/or the direction of the rotational input from a front shaft 98 to a new output rotation of the rear shaft 84, thus determining the steering behavior of the dolly. A detailed discussion of this operation will be presented in the operation section, however we will summarize the specifications here that would be needed when ordering this gearbox from a manufacturer.

When ordering the gearbox, the following requirements will need to be specified. The input rotation enters the front of the box, and the desired gear ratio must be available to the shaft coming out the back. Note also that the output rotation must be reversed by the gearbox.

A shaft 98 comes out the front of the main gearbox 88. The front end of the shaft 98 connects to a 90-degree gear 92. The 90-degree gear 92 connects to a larger 90-degree gear 94 in a manner that is similar to the connections to the rear partial-circular track 68 except that gear 92 is above gear 94. A smaller gear 96 below gear 94 is rigidly attached to gear 94 so that its axis coincides with the axis of gear 94. This smaller gear 96 then meshes and presses tightly against the back of a forward partial-circular track 100 while a roller 102 rolls tightly against the front or inside of the forward partial-circular track 100. As the forward trailer 54 (FIG. 1) turns, the forward partial-circular track 100 is forced to move between the roller 102 and the gear 96, causing the 90 degree gear 94, and thus the attached linkages to rotate.

The forward partial-circular track 100 is attached to the forward trailer 54 (FIG. 1) at its extremities via some sort of hitching device that allows pivoting around a vertical axis and some amount of pivoting around horizontal axes while preventing vertical or horizontal movement at the point of hitching to provide support and pulling force. In this embodiment, we will use standard ball hitch type latches 106L and 106R to represent the hitch arrangements for the partial-circular track 100. The heavy central member of the dolly frame 74 attaches to a larger hitching point using a similar, but larger, hitching device that will be represented by hitch latch 108. The forward trailer 54 (FIG. 1) must be modified to have hitching points compatible with the dolly hitch latches, which in this embodiment we will represent with hitch balls mounted solidly directly to each side of a heavy central hitch ball. The side hitch balls must be mounted slightly higher than the central ball to line up with their respective ball hitch latches 106L and 106R. Note that the partial-circular track 100 is not solidly attached to the main dolly frame, but travels across it, in contact with it, during turns. In this embodiment a transverse rod 110, which is a light steel bar which pivots around its centerpoint pivot 111 on the top of the main dolly frame 74, and which is not in any way a necessary part of the invention, is provided for convenience during hitching. It does not connect to the forward partial-circular track 100 at its ends, but allows the ends of the forward partial-circular track 100 to slide slightly from side to side in short slots 112L and 112R. This transverse rod 110 also provides support for the ends of the forward partial-circular track 100 when the dolly 50 is not hitched to a towing vehicle.

At the back of the dolly, the main dolly frame 74 widens out with supporting braces 160 to become more robust. FIG. 4 will show more details of the back section of the dolly.

FIG. 4—View of Geared Cornering Mode Dolly with Traction Kinking from the Back Looking Forward

FIG. 4 shows a view of the back of the geared cornering mode dolly with traction kinking. Note that the transverse axle 64, which was discussed above, has an attachment at the top via a track attachment assembly 66L and 66R to the extremities of the large rear partial-circular track 68. The attachment assemblies 66L and 66R are designed solidly, but they attach to the back of the transverse axle 64 so that the space directly above the axle and forward is empty. This allows more than 180 degrees of rotation of the axle hanger assembly 75 (FIG. 2) about the vertical axle hanger central pivot 126.

Below the main dolly frame 74 the heavy axle hanger central pivot 126 supports and allows pivoting of the axle hanger assembly 75 and of the transverse axle 64 with its associated components. Thus, the axle hanger assembly 75 and the transverse axle 64 are allowed to pivot below the main dolly frame 74 in response to the torque applied by the rear partial-circular track 68. More details of the axle hanger assembly 75 and of its attachment to the transverse axle 64 are shown in FIG. 5.

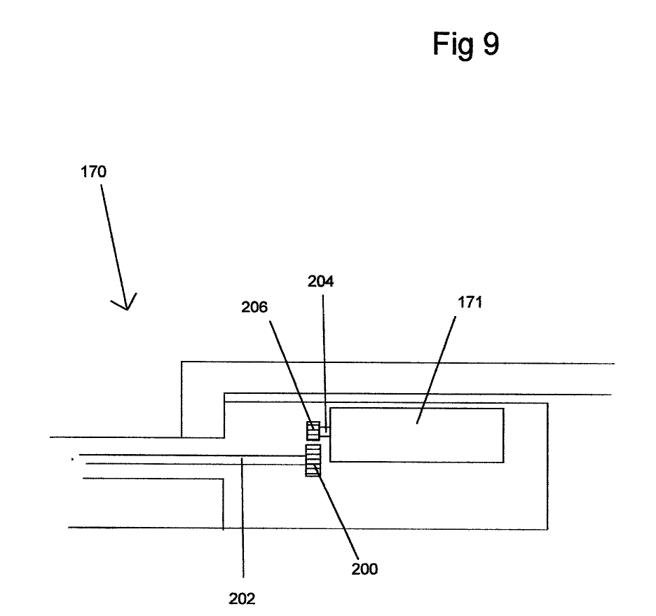

The air motor assemblies 170 R, L that comprise the power source for the kinking drive system are mounted behind the transverse axle 64 on each side. Each air motor assembly 170 R, L includes gearing to slow the rotation to the appropriate speed and to increase the torque. The output from each air motor assembly 170 R, L is applied via a gear 200 (FIG. 9) on a drive shaft 202 (FIG. 9) that extends out through the center of each wheel 62 R, L. The wheels 62 R, L and the shafts are mounted on bearings in a similar manner to the drive wheels on the back of a truck tractor. No differential is needed, because the two air motors 170 R, L have a common air supply and will apply equal torques to the shafts 200 they are driving. More details of these air motor assemblies 170 R, L will be shown in FIG. 9.

FIG. 5—End View Detail of Transverse Axle and Axle Hanger Assembly

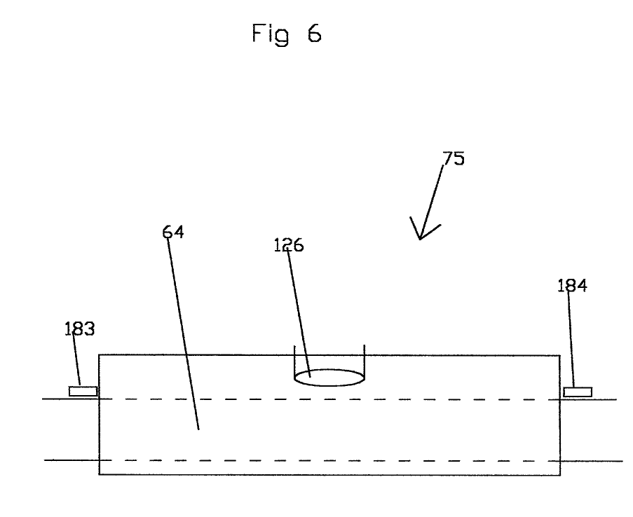

FIG. 5 shows a view of a detail of the transverse axle 64 inside the axle hanger assembly 75. Since the input to the kinking system is the sideways force on the dolly axle 64, we must have some way of measuring this force. In this alternate embodiment of the invention, the transverse axle 64 is mounted in an axle hanger assembly 75 that allows some movement from side to side in response to a sideways force. This movement is used to activate air regulator switches 190 (FIG. 6) (or some such device) on each side, which then power the kinking system.

FIG. 5 shows a detailed view of the axle 64 mounted in the axle hanger assembly 75. The axle 64 is mounted in the center of an inverted U-shaped channel 172 in the axle hanger assembly 75. The weight on the axle 64 is supported by a number of vertical arms 174 each of which attach via a pivot 176 at the top to the axle 64 and via a pivot 177 at the bottom to the lower sides of the U-shaped channel 172. When a sideways force is applied to the axle 64, the vertical arms 174 swing somewhat to the side in response to the force. At the top and bottom of the channel 172, roller bearings 180, 181 in partial-circular races 182, 183 stabilize the axle 64 against forward and/or backward forces and against twisting movement.

FIG. 6—Detail of Location of Regulator Switches on Axle Hanger Assembly

FIG. 6 is a detail of the location of regulator switches 183, 184 on the axle hanger assembly 75. The axle 64 is shown passing through the axle hanger assembly 75, which rotates on the vertical axle central pivot 126. The movement of the axle 64 in response to the sideways forces upon it activates a regulator valve or switch 183, 184 placed on each side of the axle 64 (FIG. 6). Full air pressure from the truck air system is applied to the input side of these switches 183, 184. The switches 183, 184 are designed to send increasing pressure to the kinking system as the sideways force increases, in just the opposite manner to the way the force on the brake pedal reduces the pressure to the brakes in an air brake system. During a turn, if the sideways pressure tries to push the dolly 50 (FIG. 1) to the inside of the turn, air pressure is sent to the air motors 171 (FIG. 9) in the air motor assembly 170 L, R (FIG. 4, 9) to push the dolly wheels 62 L, R (FIG. 4) forward, relieving the pressure. If the sideways pressure tries to push the dolly 50 (FIG. 1) to the outside of the turn, air pressure is sent to the brake activation system to slow the dolly 50 (FIG. 1) and eliminate the risk of jackknifing. The details of how the air from each of the regulator switches 183, 184 is routed are shown in FIG. 7.

FIG. 7—Kinking Logic System

FIG. 7 is a detail of the kinking logic system. The kinking logic system controls the final routing of the air pressure which does the work of kinking or un-kinking as needed. This system is located inside the kinking logic system gearbox 82 (FIG. 3). As the rear partial-circular track 68 (FIG. 3) and the dolly axle 64 (FIG. 3) turn from side to side, the shaft 80 coming into the kinking logic system gearbox 82 (FIG. 3) from the back rotates clockwise and counterclockwise. Inside the kinking logic system gearbox 82 (FIG. 3) another gear 186 moves in contact with a gear 185 on this shaft 80 and transfers this rotation to a second screw shaft 188. A substantial portion of the length of this screw shaft 188 is covered with coarse square-edged threads. A regulator valve activator block 190 is threaded onto these threads, and the rotation of the screw shaft 188 causes this regulator valve activator block 190 to move back and forth as the dolly axle 64 (FIG. 3) changes orientation. The position of this regulator valve activator block 190 controls where the air pressure is sent from the regulator switches 183, 184 (FIG. 6) located on the axle 64 (FIG. 3). If the regulator valve activator block 190 is to the left of its center position it activates a double regulator valve 191. Then the air pressure coming through the double regulator valve 191 from the left regulator switch 183 (FIG. 6) is sent to the air motors 171 (FIG. 9) to help move the dolly forward and any air pressure from the right regulator switch 184 (FIG. 6) is sent to the brake system to slow the dolly down and prevent a jackknife. If the regulator valve activator block 190 is to the right of its center position it activates a double regulator valve 193. Then the air pressure from the left regulator switch 183 (FIG. 6) is sent to the brake system, and any air pressure from the right regulator switch 184 (FIG. 6) is sent to the air motors 171 to speed the dolly up. In addition, if the regulator valve activator block 190 is near its center position, indicating that the dolly wheels 62 L, R (FIG. 3) are close to alignment with the dolly centerline, the air pressure from either of the regulator switches 183, 184 is substantially reduced by whichever of the double regulator valves 191 or 193 is activated. Since any force applied by the wheels 62 R, L (FIG. 2) parallel to the dolly centerline would simply be resisted by the hitch assembly, this reduction saves wear and tear on the system. If the regulator valve activator block 190 is substantially away from its center position in either direction, the air pressure from the regulator switches 183, 184 (FIG. 6) is not reduced.

FIG. 8—Air Pressure Converter Detail

FIG. 8 is a detail of the air pressure converter located inside the kinking logic gearbox 82. The air pressure from the above kinking logic gearbox (FIG. 3) is always positive, but air brakes are activated by a lack of pressure. The kinking logic system gearbox includes a converter to change the positive air pressure into a lack of pressure for the dolly and the trailer brakes. As the braking air pressure from the kinking logic system increases, it activates an air cylinder 192 which pushes on another regulator valve 194 that is constructed like the brake pedal on an air brake system. The air line for the trailer and dolly brakes runs through this regulator valve 194, and as the regulator valve 194 is pushed, air pressure is removed from the air line to the dolly and the trailer brakes, causing them to be activated.

FIG. 9—Details of the Air Motor Assembly

FIG. 9 is a detail of the air motor assembly. The two similar air motor assemblies 170 R, L convert the air pressure sent from the kinking logic system into torque to drive the dolly wheels 62 L, R. (FIG. 3) Each assembly includes a system of gears to reduce the speed and increase the torque of the air motors 171. When the air motors 171 are activated, the shaft 204 and gear 206 carrying the output rotation from the air motor assembly 170 engages a gear 200 on the end of the axle shaft 202 that extends out through the center of the wheels 62 L, R (FIG. 3) on each side of the dolly. This shaft 202 then causes the wheels 62 R, L to drive forward in a manner similar to the way the drive wheels of the truck tractor operate. Since the two air motor assemblies 170 R, L share a common air pressure source, no differential gears are needed to equalize the torques on the wheels.

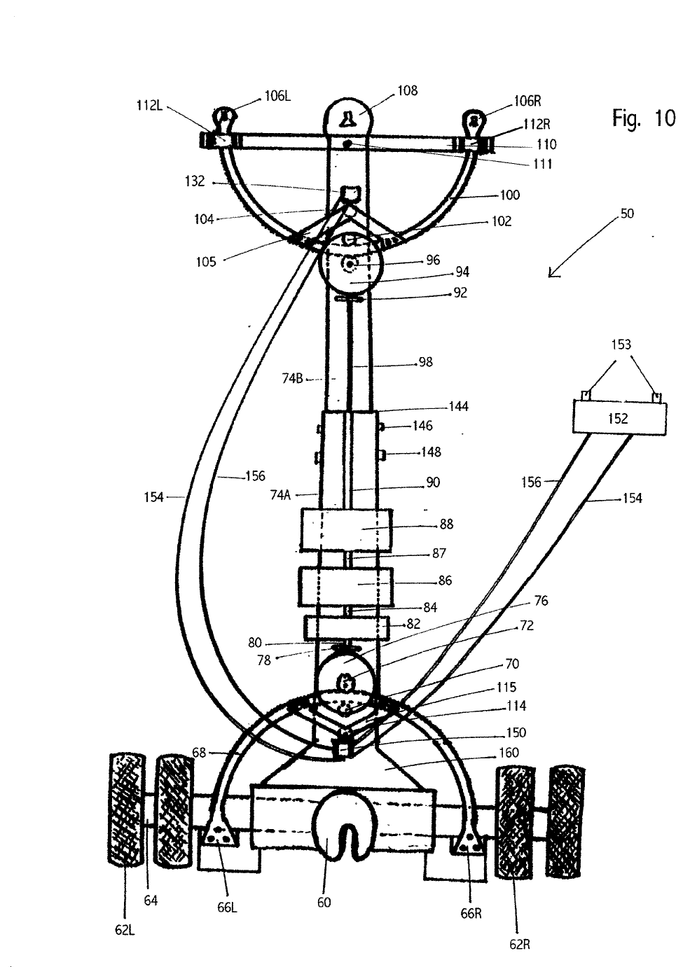

FIG. 10—Preferred Embodiment of Invention Using a Switchable Geared Dolly with Traction Kinking

FIG. 10 shows a view from above of a preferred embodiment of the invention, using a switchable geared dolly with traction kinking. This preferred embodiment of the invention is very similar to the geared cornering steerable embodiment of the invention except that the dolly length is adjustable and the steering gear ratio can be changed without stopping the vehicle. This allows the dolly to be operated as a Stability Steerable dolly at higher speeds on the open road, then shifted into a different mode to operate as a Cornering Steerable dolly for better cornering ability at lower speeds.

FIG. 10 shows a view of the primary sections of the dolly 50 from above. The transverse axle 64 has an attachment at the top via a track attachment assembly 66L and 66R to the extremities of a large rear partial-circular track 68. The attachment assemblies 66L and 66R are designed solidly, but they attach to the back of the transverse axle 64 so that the space directly above the axle and forward and somewhat backward is empty. This allows more than a full 180 degrees of rotation of the axle hanger assembly about a vertical axle hanger central pivot 126 (FIG. 4), located directly under the fifth wheel 60. The bottom of the rear partial-circular track 68 is in the same plane with the top of the main dolly frame 74. The gear teeth on the front of the rear partial-circular track 68 are sized to mesh with the teeth of a small gear 72 mounted on the main dolly frame 74a. This rear partial-circular track 68 passes between a roller 70 and the small gear 72 on the top of the main axial member of the trailer frame 74. The roller 70 and the gear 72 are positioned to press tightly against the sides of the rear partial-circular track 68 so that as the gear 72 rotates, it causes the rear partial-circular track 68 to move between the gear 72 and the roller 70. This in turn will cause the axle 64 to rotate about a vertical axis, changing the orientation of the dolly running wheels 62L and 62R. The small gear 72 is rigidly attached to a large gear 76 above it, both of which rotate about the same axis. The large gear 76 is mounted high enough to easily stay clear of the rear partial-circular track 68 as it moves. The large gear 76 has 45 degree teeth along its outer lower edge designed to mesh with a smaller gear 78 rotating at a 90 degree angle to it and located directly below its front edge. This smaller gear 78 which is rotating around an axis parallel to the main axial member of the main dolly frame 74 is mounted on a shaft 80 which passes into a kinking logic system gearbox 82 through the back wall of the kinking logic system gearbox 82. This kinking logic system gearbox 82 keeps up with the orientation of the rear partial-circular track 68 and of the transverse axle 64 in order to determine when air pressure for the kinking drive system should be disabled and/or switched to braking air pressure.

A shaft 84 coming out through the front wall of the kinking logic system gearbox 82 goes through another wall and into a neutral lock gearbox 86 through the back wall of the neutral lock gearbox 86. This neutral lock gearbox 86 performs its functions at the beginning and at the end of each shifting sequence. It starts each mode shifting sequence by disconnecting all steering gears in front of the neutral lock gearbox 86 from all steering gears behind it and then locking the gears behind it into a static position. Then after all other shifting operations are completed, and when a forward enabling switch 132 indicates that the forward section is aligned, the neutral lock gearbox 86 completes the sequence by unlocking and reconnecting the gears behind it to the gears in front of it. Since no shifting sequence can begin unless a rear enabling switch 150 has indicated that the rear section is in alignment, this method assures that at the completion of each shifting sequence, all sections are properly aligned and centered. The operation of this rear-enabling switch 150 will be dealt with more fully later on in this section In practice, of course, all these events may take place in a very short interval of time, since all the actions are automatically controlled by air pressure. It is worth noting here that while the neutral lock gearbox 86 has the back section locked, the dolly 50 will be operating in the standard non-steerable A mode. This mode could thus be easily made available if desired, but it would not have an advantage over the other two modes, which are available.

A shaft 87 coming out through the front wall of the neutral lock gearbox 86 goes through another wall and into the main gearbox 88. The purpose of this main gearbox 88 is to select the dolly operating mode by changing the ratio and/or the direction of the rotational input from a front shaft 90 to a new output rotation of the rear shaft 87. A detailed discussion of this operation will be presented in the operation section, however we will summarize the specifications here which would be needed when ordering this gearbox 88 from a manufacturer.

When ordering the gearbox 88, the following requirements will need to be specified. All gear shifting will be performed by high-pressure air. All gear positions must be stable; i.e. no changes in gear position can occur if no high-pressure air is applied to the system. The input rotation enters the front of the box, and two gear ratios must be available to the shaft coming out the back. The gear shifting will be performed by only two high-pressure air lines. Pressure on the first air line, which we will call the Stability air line 154, must cause the output rotation to be shifted to straight or forward, with the magnitude of the gear ratio being equal to the value calculated in the theory section for Stability mode. This gear ratio will depend on the relative lengths of the dolly 50 and the rear trailer 58 (FIG. 1), but will in general be around 0.75. Pressure on the second airline, which we will call the Cornering air line 156, will cause the output rotation to be shifted to reversed with a gear ratio of −1 (−1 rotation out to the back/one rotation in from the front). In addition to the gearing requirements, the main gearbox 88 will provide some control and information functions. The main gearbox 88 must activate switches when in a particular mode which will show the main gearbox 88 status to the driver using indicator lights 153 on a control box 152 in the drivers cab. A valve must also be provided inside the main gearbox 88 that will cut off air pressure to the traction kinking system when the gearbox 88 is not in the cornering mode. When the main gearbox 88 is shifted back into cornering mode, the air pressure will be once again supplied to the traction kinking system for assistance in turning corners.

When the rear enabling switch 150 detects alignment, the air pressure is passed through the enabling switch 150 on to the neutral lock gearbox 86 and the mode switching operation is initiated. When the forward enabling switch 132 detects alignment, the air pressure is passed on to the main gearbox 88 to allow completion of the mode switching operation At this point the air is passed on back to the neutral lock gearbox 86, to allow the reconnection of the back section of the gear train.

The control box 152 will be located in the driver's cab. The face of the control box 152 will have two indicator lights 153, one for each mode. The control box 152 will have an air valve that will turn on high pressure air to either the stability air line 154 or the cornering air line 156, but not to both, with the other line in each case dumped to atmosphere. Two high-pressure air lines will be routed between the control box and the dolly. A front shaft 90 coming out the front of the main gearbox 88 is the outer section of a splined shaft 90 having splines on the inside. The inner section of a forward shaft 98 having splines on the outside, slides inside the outer splined front shaft 90. These splined shafts 90, 98 are designed to allow the length of the main dolly frame 74 to be adjusted as needed for different rear trailer 58 lengths. Similarly, at a joint 144, a smaller main dolly frame 74b section slides into a larger main dolly frame 74a section, allowing the main frame to be easily adjusted. Two pin and lock sets 146 and 148 secure this attachment to prevent slippage or movement during operation. The front end of the splined shaft 98 connects to a 90 degree gear 92. The 90 degree gear 92 connects to a larger 90 degree gear 94 in a manner that is similar to the connections to the rear partial-circular track 68 except that gear 92 is above gear 94. A smaller gear 96 below gear 94 is rigidly attached to gear 94 so that its axis coincides with the axis of gear 94. This smaller gear 96 then meshes and presses tightly against the back of a forward partial-circular track 100 while a roller 102 rolls tightly against the front or inside of the track. As the forward trailer 54 (FIG. 1) turns, the forward partial-circular track 100 is forced to move between the roller 102 and the gear 96, causing the 90 degree gear 94, and thus the attached linkages to rotate. A roller 104 is mounted on the forward partial-circular track 100 with mounting braces 105. The roller 104 is not attached to the main dolly frame 74, but rotates with the forward partial-circular track 100. The roller mounting brace 105 passes above the roller 102 and below gear 94 as the forward partial-circular track 100 moves. When the forward section is centered, the roller 104 will be in a position which presses a forward enabling switch 132, enabling the completion of a shifting sequence. The forward partial-circular track 100 is attached to the forward trailer 54 (FIG. 1) at its extremities via some sort of hitching device that allows pivoting around a vertical axis and some amount of pivoting around horizontal axes while preventing vertical or horizontal movement at the point of hitching to provide support and pulling force. In this embodiment, we will use standard ball hitch type latches 106L and 106R to represent the hitch arrangements for the partial-circular track 100. The heavy central member of the dolly frame 74 attaches to a larger hitching point using a similar, but larger, hitching device that will be represented by hitch latch 108. The forward trailer 54 (FIG. 1) must be modified to have hitching points compatible with the dolly hitch latches, which in this embodiment we will represent with hitch balls mounted solidly directly to each side of a heavy central hitch ball. The side hitch balls must be mounted slightly higher than the central ball to line up with their respective ball hitch latches 106L and 106R. Note that the partial-circular track 100 is not solidly attached to the main dolly frame 74a,b, but travels across it, in contact with it, during turns. In this embodiment a transverse rod 110, which is a light steel bar which pivots around its centerpoint pivot 111 on the top of the main dolly frame 74, and which is not in any way a necessary part of the invention, is provided for convenience during hitching. It does not connect to the forward partial-circular track 100 at its ends, but allows the ends of the forward partial-circular track 100 to slide slightly from side to side in short slots 112L and 112R. This transverse rod 110 also provides support for the ends of the forward partial-circular track 100 when the dolly 50 is not hitched to a towing vehicle.

Moving toward the back of the dolly, a roller 114 is mounted in a manner similar to the front roller 104 so that its mounting brace 115 passes between gear 72 and the roller 70 as the gear 72 causes the rear circular track 68 to move. When the axle 64 is perpendicular to the main dolly frame 74, the roller 114 causes the rear enabling switch 150 to be activated, enabling the initiation of a mode shifting sequence when the driver has signaled for a mode change. The main dolly frame 74 widens out with supporting braces 160 in the back to become more robust. FIG. 4 will show more details of the back section of the dolly.

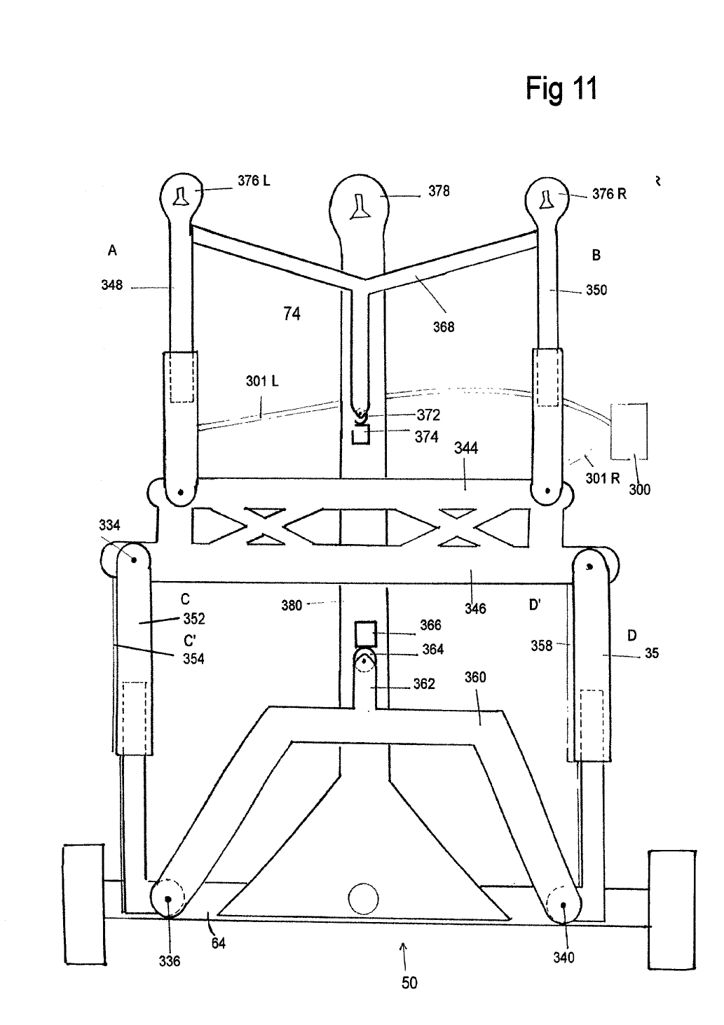

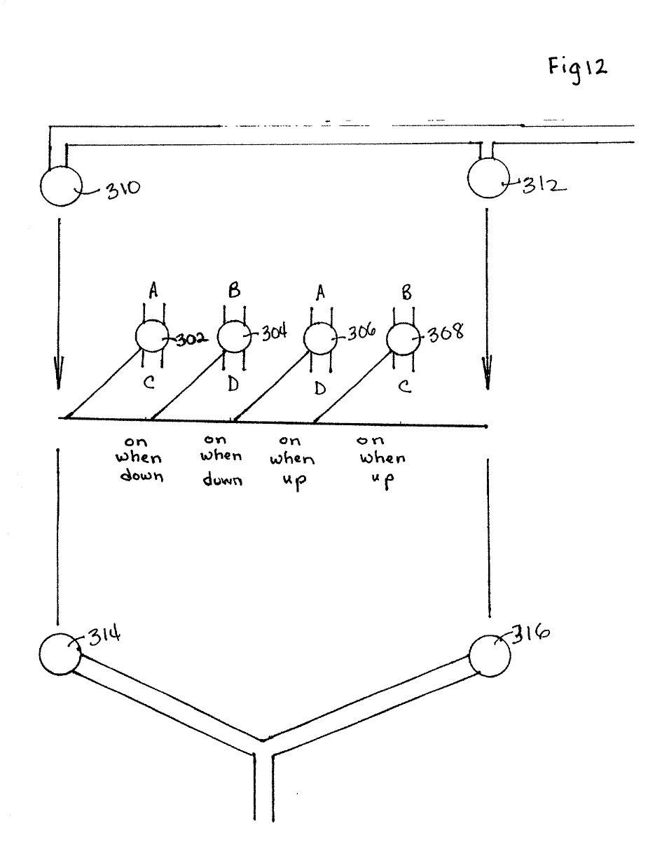

FIG. 11—Alternative Embodiment of the Invention Using Hydraulic Cylinders to Steer Dolly

FIG. 11 shows an alternative embodiment of the invention involving hydraulic cylinders. In this embodiment, which we will call the switchable hydraulic dolly with traction kinking, the input to the steering system is via hydraulic cylinders A 348 and B 350 located near the front of the dolly 50. The hoses 301L and 301R from these cylinders A 348 and B 350 go directly to a valve box 300 that can be located anywhere that is convenient and which will control the mode switching The output hoses from the valve box 300 go to the four hydraulic cylinders C 352, C′ 354, D 356, and D′ 358 mounted toward the back of the dolly 50. The cylinder C′ 354 is mounted directly below cylinder C 352 and has common pivot points 334 and 336 with cylinder C 352. The cylinder D′ 358 is mounted directly below cylinder D 356 and has common pivot points 338 and 340 with cylinder D 356. These extra cylinders will be used to provide two extra modes for the switchable hydraulic dolly, the moderate stability mode and the moderate cornering ability mode. The moderate stability mode will produce less stability than the maximum stability mode, but will have slightly more cornering ability. The moderate cornering ability mode will have less cornering ability than the cornering ability mode, but will be slightly more stable. Note that any number of modes can be provided by simply adding valves and cylinders.

All six of the cylinders for the switchable Hydraulic dolly are identical. All six cylinders have their bases mounted on reinforced mounting beams 344 and 346 welded above the main dolly frame 74. The mounting beams 344 and 346 are positioned so that each cylinder can be mounted having its axis parallel to the centerline of the dolly 50 when the vehicles are traveling in a straight line. This configuration minimizes non-linearities when the vehicle is traveling at speed along fairly straight roads. The rear pivot points 336 and 340 of cylinders C 352, C′ 354, D 356, and D′ 358 attach to a robust member, which is equivalent to the track assembly 66L 66R of the Geared Cornering Steerable embodiment (FIG. 3), rising from the transverse axle 64 in such a way as to allow free pivoting. (This member is beneath rear pivot points 336 and 340, and above the axles 64, so is not shown in this view.) Each cylinder is attached so that its axis is horizontal.

The structural portion of the back of the switchable hydraulic dolly with traction kinking is very similar to the back of the geared cornering mode dolly with traction kinking discussed above. Please refer to FIGS. 4, 5, 6, 7 and 8 for more details on this section. The traction kinking system is identical to that of the switchable geared dolly with traction kinking except that the screw shaft in the kinking logic gearbox is turned by a hydraulic motor acting as a measurement device in the hydraulic line from cylinder A.

We will now move back to FIG. 11. Attached above the point on each side of the dolly where the hydraulic cylinders C 352, C′ 354, D 356, and D′ 358 attach to their axle pivot point 336 and 340, is a solid frame 360 which extends forward in such a manner as to clear the main dolly frame 380 as it rotates. At the point where this solid frame 360 crosses the center of the main dolly frame 380, a projection 362 extends forward with a roller 364 at the end. When the transverse axle 64 (FIG. 3) is aligned for straight forward movement, this roller 364 depressed a switch 366, which will enable the initiation of a mode switching operation by the valve box. In a similar manner, a solid frame 368 extends backward from its attachment at the forward pivot points 370L and 370R of cylinders A 348 and B 350. When the forward section is aligned for straight forward motion, a roller 372 will activate a forward switch 374 to allow completion of a mode switching operation.

The hitch latches 376L,R, 378 for the switchable hydraulic dolly are essentially identical to those of the geared cornering mode dolly with traction kinking embodiment of the invention. The valve box 300 for mode switching can be located anywhere on the frame that is convenient with hoses running to each cylinder. The details of its operation will be dealt with in the operation section.

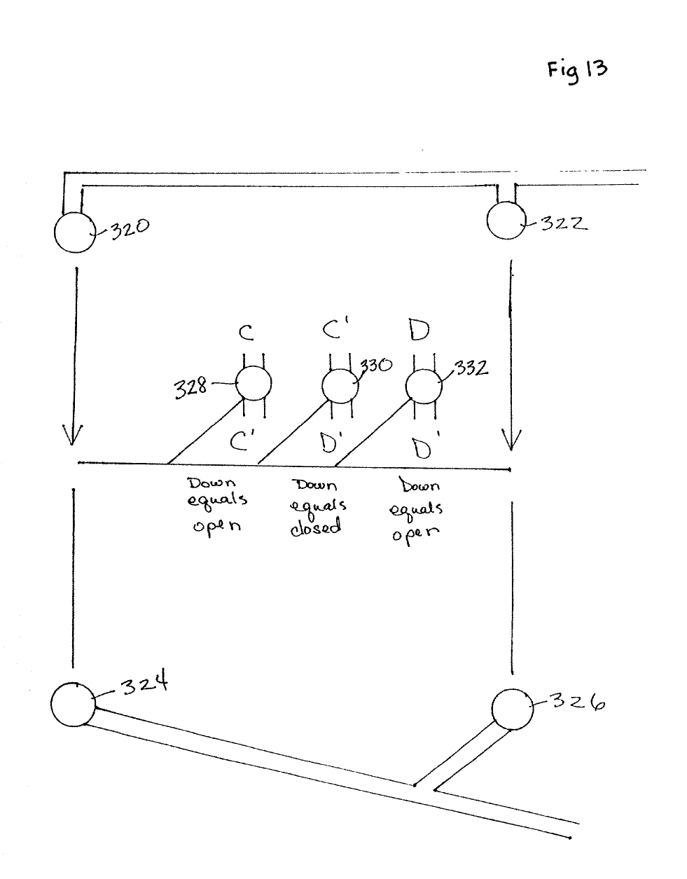

FIG. 12—Valve Box Diagram of Valves Used for Switching between Stability and Cornering Modes of Switchable Hydraulic Dolly

FIG. 12 shows a symbolic representation of the valves used for switching between the stability and the cornering modes with the switchable hydraulic dolly. These valves are located inside the valve box, and the switching is performed by air operated cylinders. Valve 302 connects cylinder A 348 (FIG. 11) to cylinder C 352 (FIG. 11) when switched down. Valve 304 connects cylinder B 350 (FIG. 11) to cylinder D 356 (FIG. 11) when switched down. Valve 306 connects cylinder A 348 (FIG. 11) to cylinder D 356 (FIG. 11) when switched up. Valve 308 connects cylinder B 350 (FIG. 11) to cylinder C 352 (FIG. 11) when switched up. Air cylinders 310 and 312 switch the ganged valves down when activated, and air cylinders 314 and 316 switch the ganged valves up when activated.

As will be discussed in the section on operation, cylinder A 348 (FIG. 11) will be connected to cylinder C 352 (FIG. 11) when the stability modes are being used and cylinder B 350 (FIG. 11) will be connected to cylinder D 356 (FIG. 11). This is the position that is shown in FIG. 7. When the air cylinder below the valves in the diagram is actuated, the ganged valves will switch to the up position, which will correspond to the cornering modes. In these modes, cylinder A 348 (FIG. 11) will be connected to cylinder D 356 (FIG. 11) and cylinder B 350 (FIG. 11) will be connected to cylinder C 352 (FIG. 11).

FIG. 13—Diagram of Valves Used for Switching between Maximum and Moderate Modes of Switchable Hydraulic Dolly

FIG. 13 shows a symbolic representation of the valves used for switching between the maximum and the moderate modes with the switchable hydraulic dolly. These valves are located inside the valve box, and the switching is performed by air operated cylinders. Valve 328 connects cylinder C 352 (FIG. 11) to cylinder C′ 354 (FIG. 11) when switched down. Valve 330 connects cylinder C′ 354 (FIG. 11) to cylinder D′ 358 (FIG. 11) when switched up. Valve 332 connects cylinder D 356 (FIG. 11) to cylinder D′ 358 (FIG. 11) when switched down. Air cylinders 320 and 322 switch the ganged valves down when activated, and air cylinders 324 and 326 switch the ganged valves up when activated.

As was discussed above, a cylinder C′ 354 (FIG. 11) which is identical to cylinder C 352 (FIG. 11) is located directly below cylinder C 352 (FIG. 11) and is attached to the same pivot points as cylinder C 352 (FIG. 11). Similarly, a cylinder D′ 358 (FIG. 11) which is identical to cylinder D 356 (FIG. 11) is located directly below cylinder D 356 (FIG. 11) and is attached to the same pivot points as cylinder D 356 (FIG. 11). In the moderate modes, the hydraulic fluid from the front input cylinders is shared between cylinders C 352 (FIG. 11) and C′ 354 (FIG. 11) and between cylinders D 356 (FIG. 11) and D′ 358 (FIG. 11). As a result, the movement of the dolly axle will be only half as much as if the fluid had not been shared. In the maximum modes, the fluid sharing is disabled, and the two cylinders C′ 354 (FIG. 11) and D′ 358 (FIG. 11) simply'share a common reservoir of fluid as their pivot points move. The position that is shown in FIG. 13 (FIG. 11) is the moderate position with the input fluid being shared between cylinders C 352 (FIG. 11) and C′ 354 (FIG. 11) and between cylinders D 356 (FIG. 1) and D′ 358 (FIG. 11). If air is applied to the bottom air cylinders, the ganged valves will switch to their up positions, and the sharing will be disabled for the maximum mode. Cylinder C′ 354 (FIG. 11) is now connected to cylinder D′ 358 (FIG. 11) for fluid sharing. Since they attach on opposite sides of a pivot point, any gain by one should correspond to a loss by the other.

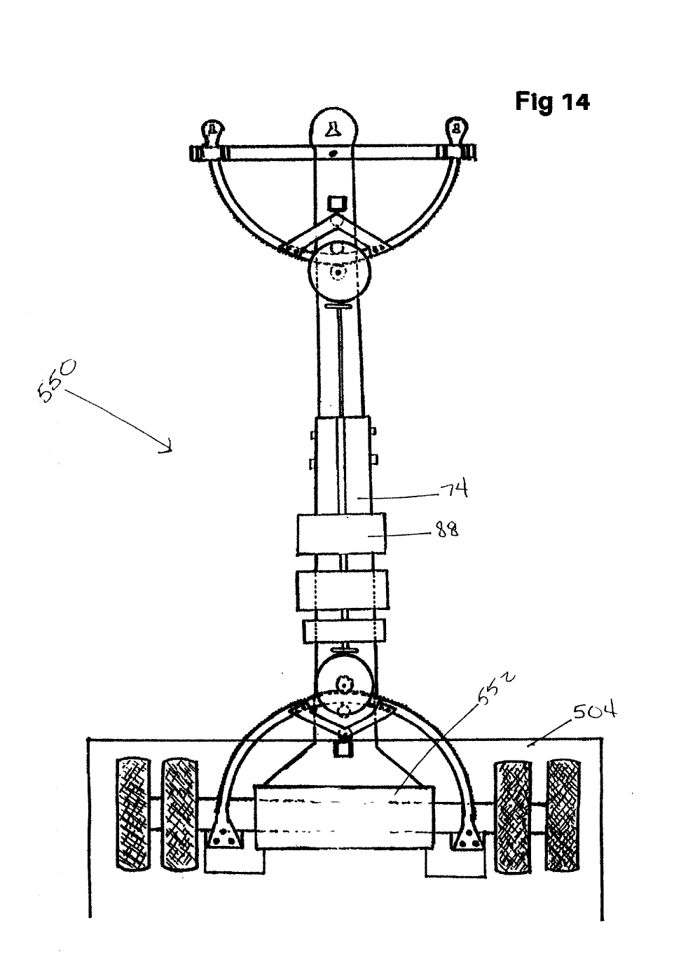

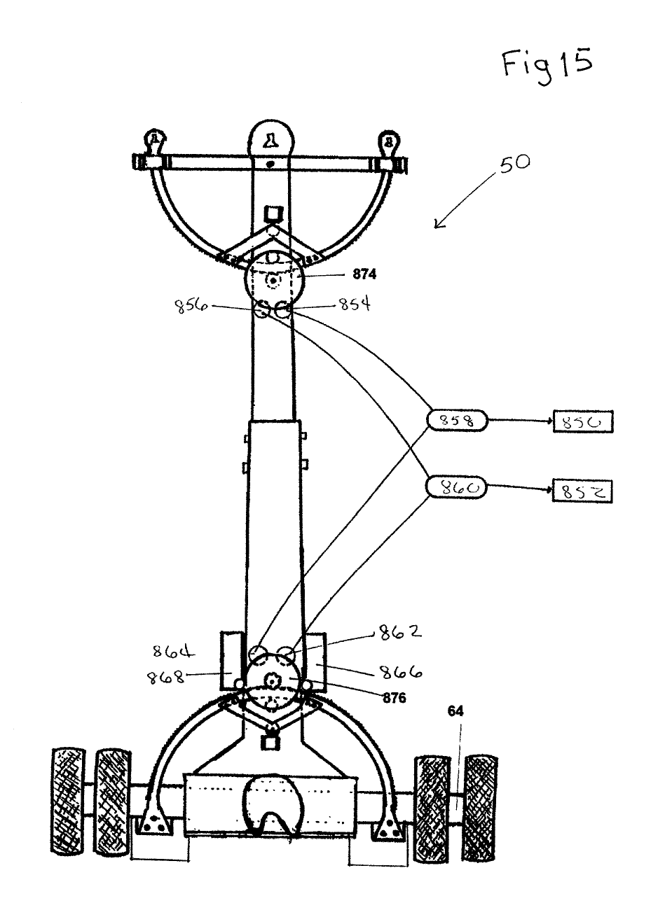

FIG. 14—a Double-Axle Wagon Utilizing the Switchable Geared Type of Steering and Traction Kinking to Control Towing Characteristics of the Trailer

FIG. 14 shows a double-axle trailer or wagon 550 that utilizes switchable geared steering with traction kinking. This wagon 550 is designed to be pulled behind a three-quarter ton pickup, so it will be accordingly sized down somewhat from the switchable geared dolly with traction kinking 50 (FIG. 1). As was true for the switchable geared dolly with traction kinking (FIG. 1), however, this wagon 550 will require three hitch balls on the towing vehicle. The steering system for this wagon 550 is identical to that for the switchable geared dolly with traction kinking 50 (FIG. 1) except that control and shifting by the driver will utilize 12 volt solenoids and/or 12 volt DC motors instead of the air cylinders used by the switchable geared dolly with traction kinking 50 (FIG. 1). The gearbox 88 will be accordingly selected or modified to be compatible with the above. Gear ratios may also be somewhat different for the wagon 550 than for the dolly. The back portion of the trailer or wagon 504 will be permanently attached to the raised section of the front part of the main wagon frame 552, so there will be no need for the fifth wheel that was present on the dolly.

The traction kinking system must also be modified to operate on 12 volt DC power, and an extra battery may be needed to supply the additional current The air motors powering the steering wheels will be replaced by 12 volt DC motors similar to the engine starting motors commonly found on passenger vehicles. The regulator switches and valves will be replaced by variable resistance rheostats. Again, the traction kinking system will be disabled when the steering wheels of the wagon are aligned with the centerline of the wagon tongue.

FIG. 15—Switchable “Digital Dolly” with Traction Kinking Utilizing a Microprocessor for Steering the Dolly

The switchable digital dolly with traction kinking 50 shown in FIG. 15 is identical to the original switchable geared dolly with traction kinking except that the steering information is transferred from the front to the back of the dolly 50 by microprocessors 850 and 852. The software in microprocessors 850 and 852 will do all mode switching so that no gearbox will be required. Full redundancy is shown here for all the electronic components to minimize the consequences of failures, although this is optional to the invention.

At the front of the dolly 50, two identical optical pulse rotation encoders 854 and 856 will record the rotation of the forward gear 874 and transfer this information via pulse counting circuits 858 and 860 to the two identical microprocessors 850 and 852. At the rear of the dolly 50 two other identical optical pulse rotation encoders 862 and 864 will record the rotation of the rear gear 876 Two reversible air motors 866 and 868 geared down to a moderate speed will provide the energy for turning the axle 64 when the software detects that movement is required. These air motors 866 and 868 are provided with automatic braking mechanisms which lock the gear train into position at times when no action is required of the air motors 866 and 868. Loss of air pressure will also activate the braking mechanisms.

The software in the microprocessors 850 and 852 will compare the number of rotations input from the front to the number of rotations input from the back. For a 1-to-1 reverse ratio, the software will control the air motors 866 and 868 to force exactly the same number of reverse rotations from the back as it received forward rotations from the front. A positive rotation in from the front is one that results when the forward trailer turns more to the right with respect to the dolly centerline. Other gear ratios for other modes would be handled by simple mathematical manipulation of the pulse counts from the back encoders. The primary microprocessor 850 would be in control at any time with the secondary microprocessor 852 continually performing a check on the operation of the primary microprocessor 850. Any significant discrepancies would be reported to the driver as a warning and the driver would have the ability to switch to the secondary system if the situation warranted it.

The alignment of the transverse axle hanger assembly is also monitored by the computer utilizing the input from the optical rotation encoders. Thus, the kinking logic system is also replaced in this model by software in the computer. During a turn to the left, air pressure from the left regulator switch on the dolly axle is routed to the air motors and air pressure from the right regulator switch is routed to the kinking braking system. During a turn to the right, air pressure from the left regulator switch on the dolly axle is routed to the kinking braking system and air pressure from the air pressure from the right regulator switch is routed to the air motors. Additionally, when the dolly wheels are more in alignment with the dolly centerline, the air pressure from either regulator switch is substantially reduced to save wear-and-tear on the kinking system.

The traction kinking input system and the traction kinking output or power system for the switchable digital dolly would be identical to those for the switchable geared dolly with traction kinking. Please refer to FIGS. 4, 5, 6, 7, and 8. Traction kinking would be disabled in any stability type mode.

Operations

An Alternative Embodiment of the Invention—a Dolly That Operates in the Cornering Steerable Mode by Using Gears, and That Uses Traction Kinking to Assist in Turning Corners

Introduction

As discussed in the details Section, an alternative embodiment of the invention is the geared cornering mode dolly with traction kinking. The primary feature of interest in this alternative embodiment of the invention is its use of the traction kinking to assist in turning corners. The steering ratio (turns out the back/turns in at the front) for this embodiment is negative and the absolute value of the ratio is greater than 1.0. This ratio produces a steering behavior that is very responsive, and the dolly makes very aggressive steering moves in order to stay pretty much directly behind the forward trailer. This behavior produces good cornering capabilities for the described tractor-trailer combination. However, this behavior also produces substantial sideways stresses on the dolly axle. In fact, the dolly may actually slide sideways in sharp turns if no precautions are taken. The purpose of the traction kinking system is to prevent this sideways force by either braking or by driving the dolly wheels forward at the appropriate times.

During a turn, the pull of the forward trailer on the front of the geared cornering mode dolly with traction kinking tends to stretch out the dolly or to “un-kink” it. In order to prevent the dolly from cutting directly across the corner, we must have some force that resists this stretching force. We will call any force a “kinking force” if it resists this stretching force. Most current dolly models use the resistance of the dolly tires to sideways motion as the primary kinking force. The exception to this rule is the Type B dolly, which exerts a torque on the back end of the forward trailer in order to kink the back trailer. The geared cornering mode dolly with traction kinking that is an alternative embodiment of the invention, is the first dolly that utilizes traction kinking instead of, or in addition to, the two types of kinking forces described above. The traction kinking input system senses when kinking is needed. Power is then applied to the dolly wheels via air motors in the traction kinking drive system to provide the needed kinking force.

Before we examine the traction kinking system in detail, we will cover the general features of this geared cornering mode dolly with traction kinking.

Input to the Steering System

In overview, the input to the steering system of the geared cornering mode dolly with traction kinking is derived from the angle between the forward trailer 54 and the dolly 50. This input will be picked up by the forward partial-circular track 100 and transferred via the forward part of the geartrain into the main gearbox 88. The main gearbox 88 changes the direction of the rotation and also increases the value of the gear ratio so that slightly more rotations come out of the back than go into the front. This ratio will determine the characteristics of the dolly's steering. Then the output from the gearbox 88 is transferred via the kinking logic system gearbox 82 and the back part of the geartrain to the rear partial-circular track 68. The back of the rear partial-circular track 68 is attached to the axle 64 of the dolly, and causes the axle 64 to rotate about its central pivot point 126 in response to the original input from the front of the dolly. As we mentioned above, the angle between the forward trailer 54 and the dolly 50 provides the input for our steering system. As this angle varies during a turning operation, we see from FIG. 3 that the forward partial-circular track 100 moves between the roller 102 and the small gear 96. These two rotary members are pressed tightly against the two sides of the forward partial-circular track 100 to prevent slippage of the gear 96, so that the gear 96 is forced to rotate by the movement of the forward partial-circular track 100. This rotational movement is ratioed up by 90 degree gear 94 and converted to rotation about an axis parallel to the main axial member of the main dolly frame 74 by the 90 degree gear 92. The shaft 98 then carries this rotational movement into the main gearbox 88 mounted on the main dolly frame 74.

Operation of the Gearbox

The main gearbox 88 reverses the direction of the rotation which is input from the front and also ratios the rotation up so that more turns come out of the back than went into the front of the main gearbox 88.

The specifications for ordering the main gearbox 88 were given in the description section, so we will only review them here. The input rotation enters the front of the box, and the desired gear ratio must be available to the shaft coming out the back. Note also that the direction of the output rotation must be reversed by the gearbox.

Operation of the Kinking Logic System Gearbox

The shaft 84 coming out through the back wall of the main gearbox 88 goes through another wall and into the kinking logic system gearbox 82. The kinking logic system determines the direction and/or the amount of torque needed for proper kinking of the dolly and the back trailer. If the tractor-trailer combination rig is making a left turn, a pull to the left on the axle will indicate that the drive wheels of the dolly should be speeded up, so air pressure will be applied to the air motors to cause the dolly to move forward faster. If the axle experiences a pull to the right during a left turn, it indicates that the trailer is moving too fast, trying to push the dolly along. In this case, the brakes will be applied on both the dolly and on the trailer it is supporting to slow the trailer back down and prevent the dolly wheels from being pushed sideways. In a similar fashion, a pull to the left during a right turn will cause the brakes to be applied, while a pull to the right during a right turn will cause air to be applied to the air motors powering the wheels.

In an air motor, an increase in air pressure causes an increase in torque. The automatic braking system is also designed so that an increase in pressure causes more braking to be applied. The amount of torque or braking can then be regulated by regulating the air pressure supplied to these systems. The regulation of the air pressure is performed by two complementary valving systems. The regulator switches at the ends of the axle hanger assembly take in air from the main air supply and output pressures that are related to the amount of sideways pull experienced by the axle. These pressures are then sent to the kinking logic system, where they are further reduced if necessary, and then sent to either the braking system or the air motors as appropriate. The screw switch in the logic system detects the angle between the dolly axle and the centerline of the dolly. If the angle is close to 90 degrees, then the dolly wheels will be nearly in line with the dolly and application of traction, either forward or backward, will be ineffective. In this situation, the air pressure is further reduced by the regulator switches in the kinking logic system to reduce wear and tear on the system. If the angle between the dolly axle and the dolly centerline is significantly different from 90 degrees, then the wheels are not aligned with the dolly and traction will be quite effective in producing kinking of the dolly. Accordingly, the regulator switches in the kinking logic system do not reduce the pressures received from the axle regulator switches, but simply route them to the braking system if the trailer needs slowing or to the air motors if the trailer needs speeding up.

Output from the Gearbox to Steer the Dolly Axle

In FIG. 3 the shaft 80 carries the output rotational movement from the kinking logic system gearbox 82 to the gear 78. The gear 76 then picks up this movement, ratios it back down, and converts it back to rotation about a vertical axis. Gear 72, with the help of roller 70 then converts this rotational movement into movement of the rear partial-circular track 68 which then causes the transverse axle 64 to rotate about its central pivot point, steering the dolly 50.

The Traction Kinking Input System

The traction kinking input system is shown in FIGS. 5 and 6. In FIG. 5 we see that the input to this system comes from the sideways force on the axle of the dolly with traction kinking. The axle is mounted so that it can freely move a limited distance in response to sideways pulls. When the dolly orientation becomes such that the pull of the forward trailer places a sideways pull on the dolly, the movement of the axle is sensed by the regulator switches on either side of the axle hanger assembly. These regulator switches apply high-pressure air to either operate the brake system or to power the air motors that move the wheels forward.

The Kinking Output or “Power” System

The automatic braking system, which is a part of the geared cornering mode dolly with traction kinking, functions to resist kinking when it is inappropriate. In this capacity it acts as an effective jackknife prevention device. A jackknife is caused when the back trailer attempts to roll forward during a turn causing the dolly to “kink” into a jackknife configuration. The automatic braking system detects the excessive sideways push on the dolly axle toward the outside of a turn that is characteristic of a jackknife situation and intercedes immediately by applying the brakes to the trailer and to the dolly. Note that the positive pressure supplied by the kinking logic system must be transformed into a lack of pressure in order to apply the air brakes.

The other half of the kinking output system is the air motors that push the dolly wheels forward to provide more kinking force when it is needed. A pull on the dolly axle toward the inside of a turn indicates that more kinking force is needed. The same air pressure is supplied to both of the air motors, assuring that the torques on the two sides are equal. The pressure of the air is related to the amount of sideways pull that is being experienced by the axle.

Summary and Miscellaneous for Geared Cornering Mode Dolly with Traction Kinking

In summary, the input to the steering system of the dolly 50 is the angle between the back of the forward trailer 54 and the dolly 50. The output from the system is the orientation of the transverse axle 64, and thus of the running wheels 62R and 62L of the dolly 50. The manipulation of the input by the gearbox 88 is the key to the steering characteristics of the dolly 50 in this alternative embodiment of the invention.

A Dolly Using Gears and a Gearbox for Switching between Steering Modes, and Traction Kinking for Assistance in Turning Corners

Introduction

The primary features of interest in this preferred embodiment of the invention is its switchability between at least two steering modes without stopping the vehicle and its use of traction kinking for turning corners. At least one of these steering modes must be designed to provide stability at higher speeds, and at least one mode must be designed for better cornering ability and maneuverability. In this preferred embodiment the stability mode is the mode designed to provide stability at higher speeds. In this preferred embodiment, the cornering ability mode is the mode designed to provide more maneuverability. This mode corresponds to a type of steering that would be produced by crossed steering arms.

Input to the Steering System

In overview, the input to the steering system of the switchable geared dolly with traction kinking is derived from the angle between the forward trailer 54 and the dolly 50. This input will be picked up by the forward partial-circular track 100 and transferred via the forward part of the geartrain into the gearbox 88. The gearbox 88 chooses the mode, which will determine the characteristics of the dolly's steering. Then the output from the gearbox 88 is transferred via the back part of the geartrain to the rear partial-circular track 68. The back of the rear partial-circular track 68 is attached to the axle 64 of the dolly, and causes the axle 64 to rotate about its central pivot point 126 in response to the original input from the front of the dolly.

As we mentioned above, the angle between the forward trailer 54 and the dolly 50 provides the input for our steering system. As this angle varies during a turning operation, we see from FIG. 3 that the forward partial-circular track 100 moves between the roller 102 and the small gear 96. These two rotary members are pressed tightly against the two sides of the forward partial-circular track 100 to prevent slippage of the gear 96, so that the gear 96 is forced to rotate by the movement of the forward partial-circular track 100. This rotational movement is ratioed up by 90 degree gear 94 and converted to rotation about an axis parallel to the main axial member of the main dolly frame 74 by the 90 degree gear 92. The splined shafts 98 and 90 then carry this rotational movement into the main gearbox 88 mounted on the main dolly frame 74.

Operation of the Gearbox

The purpose of this main gearbox 88 is to select the dolly operating mode by changing the ratio and/or the direction of the rotational input from the front shaft 90 to a new output rotation of the rear shaft 84. Two operating modes are possible in this embodiment. We will assume for our purposes here that the forward partial-circular track 100 and the rear partial-circular track 68 have the same diameter and that corresponding gears in front of the main gearbox 88 are the same size as their corresponding gear behind the main gearbox 88. If the direction of the input from the front is unchanged by the gearbox 88 and the gear ratio is equal to the value calculated in the theory section below, the dolly 50 will operate in the stability mode. If the direction of the input is reversed but the gear ratio is equal to −1 (−1 revolution out to the back)/(1 revolution in at the front), the dolly 50 will operate in the cornering ability mode. These modes will be selectable by the driver from the cab without stopping the vehicle. Actual shifting will not begin, however, until the dolly 50 is lined up straight forward as sensed by the rear enabling switch 150. This prevents the off-centering and skewing that would occur if shifting could be initiated at any position. In this embodiment, shifting is initiated by activating the valve on the control box 152 in the driver's cab to place air pressure on either the stability air line 154 or the cornering air line 158. Note that a substantial interval of time may elapse before shifting is completed, since the shifting will not be initiated in the main gearbox 88 until the rear section of the dolly 50 is in alignment as signaled by the rear enabling switch 150. Air pressure in the stability air line 154 will shift the dolly 50 into the stability mode by shifting the gearbox 88 to provide straight or forward rotation at a gear ratio as calculated in the theory section below. This gear ratio will depend on the relative lengths of the dolly 50 and the rear trailer 58, but will in general be around 0.75. Air pressure in the cornering air line 156 will shift the gearbox 88 to provide reversed rotation at the output with a gear ratio of −1 (−1 rotation out to the back/one rotation in from the front). Switches inside the gearbox 88 will inform the driver as to which mode is currently in force by activating indicator lights 153 on the dashboard. All mode switch actuators in gearbox 88 are stable in position so that loss of air will not cause any mode switch In this embodiment, then, two control air lines 154, 156 and two switch indicator lines on the control box 152 will comprise the communication network between the drivers cab and the switchable geared dolly with traction kinking which is a preferred embodiment of this invention. The specifications for ordering the main gearbox 88 were given in the description section, so we will only review them here. Remember that all gear shifting will be performed by high pressure air. All gear positions must be stable; i.e. no changes in gear position can occur if no high pressure air is applied to the system. The input rotation enters the front of the box 88 and two gear ratios must be available to the shaft coming out the back. The gear shifting will be performed by only two high pressure air lines. Pressure on the first air line, which we will call the stability air line 154, must cause the output rotation to be shifted to straight or forward, with the magnitude of the gear ratio being equal to the value calculated in the theory section for stability mode. This gear ratio will depend on the relative lengths of the dolly 50 and the rear trailer 58, but will in general be around 0.75. Pressure on the second air line, which we will call the cornering air line 156, will cause the output rotation to be shifted to reversed with a gear ratio of −1 (−1 rotation out to the back/one rotation in from the front).

In addition to the gearing requirements, the gearbox 88 will provide some control and information functions. The gearbox 88 must activate switches inside the gearbox 88 when in a particular mode which will show the gearbox 88 status to the driver using indicator lights 153 on the control panel 152 in the drivers cab. An air valve 158 must also be included which is closed with its output dumped in all modes except cornering. This air valve 158 will be used to disable the air supply to the traction kinking system when in the stability mode.

At this point we will also note that the two high pressure air lines 156 and 158 (FIG. 10) used to control the mode shifting must be routed from the control panel in the driver's cab to the forward enabling switch 132 and the rear enabling switch 150. When the rear enabling switch 150 detects alignment, the air pressure is passed on to the neutral lock gearbox 82 and the mode switching operation is initiated. When the forward enabling switch 132 detects alignment, this air pressure is passed on to the main gearbox 88 to allow completion of the mode switching operation. When the main gearbox has finished the mode switching, the air pressure is passed on back to the neutral lock gearbox 86, which reconnects the back section of the geartrain.

The control box 152 will be located in the driver's cab. The face of the control box 152 will have two indicator lights 153, one for each mode. The control box 152 will have an air valve that will turn on high pressure air to either the stability air line 154 or the cornering air line 156, but not to both, with the other line in each case dumped to atmosphere. In review, two high pressure air lines 154, 156 FIG. 10) will be routed between the control box 152 and the dolly 50.

Operation of the Neutral Lock Gearbox

The shaft 84 coming out through the back wall of the main gearbox 88 goes through another wall and into the neutral lock gearbox 86. The neutral lock gearbox 86 performs its functions at the beginning and at the end of each shifting sequence. When the driver has applied pressure to one of the control air lines 154, 156, and when the rear enabling switch 150 has permitted that pressure to be transferred to the main gearbox 88, the neutral lock gearbox 86 starts a mode shifting sequence by disconnecting all steering gears in front of the neutral lock gearbox 86 from all steering gears behind it and then locking the steering gears behind it into a static position Then after all other shifting operations are completed, and when the forward enabling switch 132 indicates that the forward section is aligned, the neutral lock gearbox 86 completes the sequence by unlocking and reconnecting the gears behind it to the gears in front of it. Since no shifting sequence can begin unless the back enabling switch 150 has indicated that the rear section is in alignment and no shifting sequence can terminate unless the forward enabling switch 132 has indicated that the forward section is in alignment, this method assures that at the completion of each shifting sequence all sections are properly aligned and centered. In practice, of course, all these events may take place in a very short interval of time if the vehicles are traveling in a straight line, since all the actions are automatically controlled by air pressure. It is worth noting here that while the neutral lock gearbox 86 has the back section locked, the dolly 50 will be operating in the standard non-steerable A mode. This mode could thus be easily made available if desired, but it would have few advantages over the other two modes that are available.

Operation of the Kinking Logic System Gearbox

The shaft 84 coming out through the back wall of the neutral lock gearbox 86 goes through another wall and into the kinking logic system gearbox 82. The kinking logic system determines the direction and/or the amount of torque needed for proper kinking of the dolly and the back trailer. If the tractor-trailer combination rig is making a left turn, a pull to the left on the axle will indicate that the drive wheels of the dolly should be speeded up, so air pressure will be applied to the air motors to cause the dolly to move forward faster. If the axle experiences a pull to the right during a left turn, it indicates that the trailer is moving too fast, trying to push the dolly along. In this case, the brakes will be applied on both the dolly and on the trailer it is supporting to slow the trailer back down and prevent the dolly wheels from being pushed sideways. In a similar fashion, a pull to the left during a right turn will cause the brakes to be applied, while a pull to the right during a right turn will cause air to be applied to the air motors powering the wheels.

In an air motor, an increase in air pressure causes an increase in torque. The automatic braking system is also designed so that an increase in pressure causes more braking to be applied. The amount of torque or braking can then be regulated by regulating the air pressure supplied to these systems. The regulation of the air pressure is performed by two complementary valving systems. The regulator switches at the ends of the axle hanger assembly take in air from the main air supply and output pressures that are related to the amount of sideways pull experienced by the axle. These pressures are then sent to the kinking logic system, where they are further reduced if necessary, and then sent to either the braking system or the air motors as appropriate. The screw switch in the logic system detects the angle between the dolly axle and the centerline of the dolly. If the angle is close to 90 degrees, then the dolly wheels will be nearly in line with the dolly and application of traction, either forward or backward, will be ineffective. In this situation, the air pressure is further reduced by the regulator switches in the kinking logic system to reduce wear and tear on the system. If the angle between the dolly axle and the dolly centerline is significantly different from 90 degrees, then the wheels are not aligned with the dolly and traction will be quite effective in producing kinking of the dolly. Accordingly, the regulator switches in the kinking logic system do not reduce the pressures received from the axle regulator switches, but simply route them to the braking system if the trailer needs slowing or to the air motors if the trailer needs speeding up.

Output from the Gearbox to Steer the Dolly Axle

In FIG. 9 the shaft 80 carries the output rotational movement from the neutral lock gearbox 86 to the gear 78. The gear 76 then picks up this movement, ratios it back down, and converts it back to rotation about a vertical axis. Gear 72, with the help of roller 70 then converts this rotational movement into movement of the rear partial-circular track 68 which then causes the transverse axle 64 to rotate about its central pivot point, steering the dolly 50.

Behavior of the Switchable Geared Dolly with Traction Kinking when Backing Up

The behavior of the switchable geared dolly with traction kinking during backing operations is of particular interest. Normally a “double” is almost impossible to back, but if the dolly is shifted into stability mode, this section will behave much like a single-axle trailer with a very long wheelbase. The string will then become only slightly harder to back than a single trailer.

Summary and Miscellaneous for Switchable Geared Dolly with Traction Kinking

In summary, the input to the steering system of the dolly 50 is the angle between the back of the forward trailer 54 and the dolly 50. The output from the system is the orientation of the transverse axle 64, and thus of the running wheels 62R and 62L of the dolly 50. The manipulation of the input by the gearbox 88 is the key to the steering characteristics of the dolly 50 in this preferred embodiment of the invention. When the gearbox 88 is in the stability mode, the operation of the dolly 50 at higher speeds will be more stable. When the gearbox 88 is in the cornering mode, the rear trailer 58 will be more maneuverable and will have less of a tendency to cut the corners during turning operations.

As discussed below, the length of the dolly 50 may need to be adjusted to accommodate rear trailers 58 of different lengths. This may be accomplished by loosening the pins and locks 146 and 148, sliding the inner section of the frame 74b into or out of the outer frame section 74a at joint 144, and then re-tightening the pins and locks 146 and 148. The splined shaft 98 will slide into or out of splined shaft 90 during this operation with little resistance to maintain the integrity of the steering system's rotational transfer.

A Dolly Which Uses Hydraulic Cylinders for Steering, Which Switches between Stability Steerable Mode and Cornering Steerable Mode Using Air-Operated Valves, and Which Utilizes Traction Kinking for Cornering

The switchable hydraulic dolly with traction kinking which is presented in FIG. 11 is similar in many ways to the switchable geared dolly with traction kinking which is discussed above. Looking from the back of the dolly 50 forward as in FIG. 4, the two dollies would appear almost identical. However, the switchable hydraulic dolly with traction kinking transfers the input steering information and energy from the front of the dolly 50 to the axle 64 of the dolly 50 via hydraulic fluid instead of using rotary gearing. The switchable hydraulic dolly with traction kinking also differs from the switchable geared dolly with traction kinking in that four modes will be available instead of only two. Also, the mode switching operations will be performed inside a valve box 300 rather than a gearbox 88. Each function that is performed by the gearbox 88 in the switchable geared dolly with traction kinking 50 will be duplicated in the valve box 300 of the switchable hydraulic dolly with traction kinking. For simplicity, only the valves involved in switching between stability and cornering modes and between maximum and moderate modes will be shown in FIG. 12 and FIG. 13 respectively.

We will examine FIG. 12 first. In the two stability modes, cylinder A 348 will be connected to cylinder C 352 while cylinder B 350 will be connected to cylinder D 356. The valves 302, 304, 306, and 308 in FIG. 12 are shown latched into the stability mode since the air pressure is being applied to the top air cylinders 310 and 312 which have pushed the ganged valves to their down position. If air is applied to the bottom air cylinders 314 and 316 instead, then the ganged valves will be pushed to their up, or cornering, position. In this position, cylinder A 348 will be connected to cylinder D 356 and cylinder B 350 will be connected to cylinder C 352. Thus, toggling this valve gang changes the mode of the switchable hydraulic dolly between stability mode and maneuverability or cornering mode.

FIG. 13 shows the valves used to switch between maximum and moderate modes. From FIG. 11 we saw that cylinders C 352 and D 356 had identical cylinders C′ 354 and D′ 358 located directly underneath them and attached to the same pivots. To reduce the response of the steering system to a given input the hydraulic fluid from one of the front cylinders will be shared between cylinders C 354 and C′ 356. The movement, then, will be only half as much The same operation will be performed with cylinders D 356 and D′ 358. In FIG. 13, air pressure from the upper air cylinders 320 and 322 has latched the valves 328, 330, and 332 into the moderate mode, sharing the available input fluid between cylinders C and C′ on one side and between D and D′ on the other side. This will produce only half the axle rotation for a given turn angle of the forward trailer that would be produced if the fluid had not been shared. If air is applied to the bottom air cylinders 324 and 326 in FIG. 13, the valves will be latched back to their up position, the maximum mode, and the fluid will no longer be shared Now cylinders C′ and D′ will share a common reservoir of fluid as their attachment points move about a common pivot point at the center of the axle.

For the switchable hydraulic dolly with traction kinking, as for the switchable geared dolly with traction kinking, mode switching will only be allowed when the back of the dolly 50 is aligned forward. The control circuits from the drivers cab are similar except that positive air pressure is required to toggle any of the valve gangs, requiring a total of five control air lines. Again, switches will generate signals to inform the driver of the dolly modes. Check valves, pressure relief valves, a reservoir for the fluid, and a method for maintaining some residual pressure in the hydraulic system will be needed, but these will be standard assemblies in standard configurations. They have little to do with the unique working characteristics of this alternative embodiment of the invention and will not be discussed here.

The traction kinking system will be similar to the traction kinking system for the switchable geared dolly with traction kinking except that the screw shaft which keeps up with the orientation of the rear section is turned by a hydraulic motor acting as a measuring device in the hydraulic line from cylinder A. As the fluid moves into or out of this cylinder, the hydraulic motor will rotate this screw shaft having a regulator valve actuator block that is similar to the regulator valve actuator block 190 (FIG. 7) on the screw shaft in FIG. 7 that will control regulator valves just as in FIG. 7. The kinking input system and the kinking output system are identical to those for the geared cornering mode dolly with traction kinking.

A Double-Axle Wagon Using Switchable Geared Type Steering and Traction Kinking

FIG. 14 shows an alternative embodiment of the invention, a double-axle trailer or wagon 550 that utilizes switchable geared type steering. The mechanical parts of this wagon 550 perform in much the same manner as the switchable geared dolly with traction kinking 50 except that the driver will control the mode switching operations using 12 volt DC electricity from his truck battery instead of high pressure air. Enabling will be accomplished by switches instead of valves, and the gears will be shifted by 12 volt solenoids and/or 12 volt DC motors as required. The steerable front section of this wagon 550 will be permanently attached to the back part of the wagon 550, so no fifth wheel connectors are needed.

The gear ratios required will depend somewhat on the wagon 550 length and weight, but the same general principles that were used with the switchable geared dolly with traction kinking 50 will apply. When traveling at speed, the wagon 550 will tend to be more stable using stability type steering (a theoretical steering ratio between one and zero). This type steering will cause the wagon 550 to imitate a longer wheelbase trailer than is actually the case. For tuning corners at lower speeds, a negative ratio will cause the wagon 550 to swing more around behind the truck, not cutting the corner, as a longer wheelbase trailer would tend to do. The behavior of this wagon 550 during backing will also be of interest When the stability mode is selected the wagon 550 will back much like a two-wheeled trailer with a very long wheel-base.

The traction kinking system for the wagon must be modified to operate on 12 volt DC power, and an extra battery will be needed to supply the additional current. The air motors powering the steering wheels will be replaced by 12 volt DC motors similar to the engine starting motors commonly found on passenger vehicles. The regulator switches and valves will be replaced by variable resistance rheostats. Again, the traction kinking system will be disabled when the steering wheels of the wagon are aligned with the centerline of the wagon tongue.

A Dolly Which Uses Microprocessors and Air Motors for Steering, Which Switches Between Stability Steerable Mode and Cornering Steerable Mode Using the Software in the Microprocessors, and Which Uses Traction Kinking to Assist in Turning Corners

The switchable digital dolly with traction kinking shown in FIG. 15 is identical to the original switchable geared dolly with traction kinking except that the steering information is transferred from the front to the back of the dolly 50 by microprocessors 850 and 852 utilizing compressed air as an energy source to control the steering of the dolly 50. All mode switching will be done by the software in the microprocessors 850 and 852 so that no gearbox will be required. Full redundancy has been shown for all the electronic components to minimize the consequences of failures, although this is not necessary to the invention.

At the front of the dolly 50, two identical optical pulse rotation encoders 854 and 856 will record the rotation of the forward gear 874 and transfer this information via pulse counting circuits 858 and 860 to the two identical microprocessors 850 and 852. At the rear of the dolly 50 two other identical optical pulse rotation encoders 862 and 864 will record the rotation of the rear gear 876. Two reversible air motors 866 and 868 geared down to a moderate speed will provide the energy for turning the axle 64 when the software detects that movement is required. These air motors 866 and 868 are provided with automatic braking mechanisms which lock the gear train into position at times when no action is required of the air motors. Loss of air pressure will also activate the braking mechanisms.

The software in the microprocessors 850 and 852 will compare the number of rotations input from the front to the number of rotations input from the back. For a 1-to-1 reverse ratio, the software will control the air motors 866 and 868 to force exactly the same number of reverse rotations from the back as it received forward rotations from the front. A positive rotation in from the front is one that results when the forward trailer turns more clockwise with respect to the dolly centerline. Other gear ratios for other modes would be handled by simple mathematical manipulation of the pulse counts from the back encoders. The primary microprocessor 850 would be in control at any time with the secondary microprocessor 852 continually performing a check on the operation of the primary microprocessor 850. Any significant discrepancies would be reported to the driver as a warning and the driver would have the ability to switch to the secondary system if the situation warranted it.

The alignment of the transverse axle hanger assembly is also monitored by the computer utilizing the input from the optical rotation encoders. Thus, the kinking logic system is also replaced in this model by software in the computer. During a turn to the left, air pressure from the left regulator switch on the dolly axle is routed to the air motors and air pressure from the right regulator switch is routed to the kinking braking system. During a turn to the right, air pressure from the left regulator switch on the dolly axle is routed to the kinking braking system and air pressure from the air pressure from the right regulator switch is routed to the air motors. Additionally, when the dolly wheels are more in alignment with the dolly centerline, the air pressure from either regulator switch is substantially reduced to save wear-and-tear on the kinking system.

More Detailed and/or Theoretical Information

The above discussion contains all the information that is necessary to understand the parts of the switchable geared type steering and/or of traction kinking which are relevant to what is claimed by this patent, but a little more detail might help the reader to understand some of the less obvious points. The following presentation is believed to be correct, but in any case does not affect the validity or value of a trailer system having modes that can be switched without stopping the vehicle and/or using traction kinking to assist in turning corners.

Conditions Necessary for Maximum Stability

While in the stability mode, when the forward trailer 54 tuns to the right, the gearbox 88 causes a rotation of the dolly axle 64 about a vertical axis so that the back of the dolly 50 also swings to the right, cutting across the corner as the turn is completed. If the gear ratios are just right, the dolly 50 will stay almost exactly between the center hitchpoint of the forward trailer and the center of the rear axle of the second trailer. In this configuration, the rear trailer 58 and the dolly 50 act much like a single unit and handles in a manner similar to the way a single axle trailer with a very long wheelbase would handle.

In general, for the dolly 50 to remain directly aligned with the centerline of the rear trailer 58 without sideways scrubbing of the tires the axle must be oriented according to the following formula:

tangent A=(T/L)tangent B

where:

A is the angle between the dolly axle 64 and a line perpendicular to the dolly 50 centerline,

B is the angle between the centerline of the forward trailer and the centerline of the dolly 50,

T is the distance from the pivot point between the rear trailer 58 and the dolly 50 to the center of the back axle of the rear trailer 58, and

L is the total length of the dolly 50 and the rear trailer 58 together, from the attachment point at the front of the dolly 50 to the center of the rear axle of the rear trailer 58.

If only small turning angles are considered then A is approximately equal to tangent A, and B is approximately equal to tangent B. The above formula then reduces to:

A=(T/L)*B

If the length of the rear trailer 58 is 30′ and the length of the entire vehicle assembly is 45′, the gearbox 88 must rotate the dolly axle 2 degrees for every 3 degrees of movement between the centerline of the forward trailer 56 and the dolly 50 centerline. When the relative diameter of the forward 100 and the rear 68 partial-circular tracks and the diameters of the respective forward and rear gears are known, this relationship will allow us to calculate the gear ratio which will be required from our gearbox 88 to produce the maximum stability mode. If the gear ratio (rotations out to the rear of the gearbox/rotations in to the box from the front) approaches zero, the maneuverability of the linked vehicles is improved at the expense of stability as the dolly 50 approaches the configuration of the standard Type A dolly.

In the cornering mode, the switchable dolly handles as if it had crossed steering arms. When the forward trailer 54 turns to the right, this dolly 50 turns its steering axle to the left to swing wide around the corner. The gear ratio (rotations out to the rear of the gearbox/rotations in to the front) for this mode is not as critical as for the trailer locking stability mode. It will be clear, however, that negative gear ratios that approach zero will produce less pronounced cornering capabilities but better stability as the mode again approaches the behavior of the standard Type A dolly.

As mentioned above, steerable type B behavior is produced if we let the gear ratio of the switchable dolly approach negative infinity (infinite reversed turns out the back for one turn in at the front), that is, even the slightest turn causes a large correction and the dolly swings instantly into line behind the forward trailer. We have noted that for this embodiment, hydraulic cylinders or some such device must be used to force the dolly to move in the direction perpendicular to the axle of the dolly because the required movement is so strongly against the natural tendency of the system.

1. A system in an articulated vehicle that accelerates or decelerates a trailing section of the vehicle in order to produce, as needed during cornering operations, a change in the velocity or movement of the trailing section(s) other than the direction of the pull (or push) exerted on the trailing section by the forward section(s);

2. The system in claim 1 in which the change in the velocity or movement of the trailing section(s) is achieved by applying a forward or backward torque to the wheels of a trailing section of the vehicle, thus using the forward (or backward) traction of the wheels against the pavement to produce the needed change in the velocity or movement of the trailing section(s) other than the direction of the pull (or push) exerted on the trailing section by the forward section(s);

3. The system in claim 1 or claim 2 in which the change in the velocity or movement of the trailing section(s) that is needed during cornering operations causes an increase (or decrease) in the rate of change of the angle between the centerline of the section in front of the wheels and the centerline of the section in back of the wheels, thus compensating for the inability of the pull (or push) exerted on the trailing section by the forward section(s) to produce acceleration or movement as needed in a direction other than the direction of the pull (or push) exerted on the trailing section by the forward section(s) during cornering operations;

4. The system in claim 1 or 2 or 3, in which the change in the velocity or movement of the trailing section(s) is only caused when the vehicle is turning a corner,

5. The system in claim 1 or 2 or 3 or 4 in which the articulated machine is a dolly;

6. The system in claim 1 or 2 or 3 or 4 or 5 in which energy is added by a hydraulic motor, causing the change in the velocity or movement of the trailing section(s);

7. The system in claim 1 or 2 or 3 or 4 or 5 in which energy is added by a combustion engine, causing the change in the velocity or movement of the trailing section(s);

8. The system in claim 1 or 2 or 3 or 4 or 5 in which energy is added by an air motor, causing the change in the velocity or movement of the trailing section(s);

9. The system in claim 1 or 2 or 3 or 4 or 5 in which energy is added by an electric motor, causing the change in the velocity or movement of the trailing section(s);

10. The system in claim 1 or 2 or 3 or 4 or 5 in which energy is added by some other means, causing the change in the velocity or movement of the trailing section(s);

11. The system in claim 1 or 2 or 3 or 4 or 5 or 6 or 7 or 8 or 9 or 10 in which the change in the velocity or movement-of the trailing section(s) is caused by the removal of energy by the air brakes;

12. The system in claim 1 or 2 or 3 or 4 or 5 or 6 or 7 or 8 or 9 or 10 in which the change in the velocity or movement of the trailing section(s) is caused by the removal of energy by the hydraulic brakes;

13. The system in claim 1 or 2 or 3 or 4 or 5 or 6 or 7 or 8 or 9 or 10 in which the change in the velocity or movement of the trailing section(s) is caused by the removal of energy by some other means;

14. The system in claims 1 or 2 or 3 or 4 or 5 or 6 or 7 or 8 or 9 or 10 or 11 or 12 or 13 in which the information on the sideways force is acquired from sensors located on an axle;

15. The system in claim 1 or 2 or 3 or 4 or 5 or 6 or 7 or 8 or 9 or 10 or 11 or 12 or 13 in which the information on the sideways force is acquired from a tension sensor on the tongue, a sensor that determines the angle between the tongue and the wheels, and an accelerometer mounted on the steering axle assembly;

16. The system in claim 1 or 2 or 3 or 4 or 5 or 6 or 7 or 8 or 9 or 10 or 11 or 12 or 13 in which the information on the sideways force is acquired by some other means;
